(19) United States
(12) Patent Application Publication
(10) Pub. No.: US 2015/0033260 A1
(43) Pub. Date: Jan. 29, 2015

(54) METHOD AND APPARATUS FOR PROVIDING INFORMATION ABOUT BROADCASTING PROGRAM AND MEDIUM THEREOF

(71) Applicant: SAMSUNG ELECTRONICS CO., LTD., Suwon-si (KR)

(72) Inventors: Won-ho RYU, Suwon-si (KR); Young-hee PARK, Seoul (KR); Il-hwan CHOI, Suwon-si (KR)

(73) Assignee: SAMSUNG ELECTRONICS CO., LTD., Suwon-si (KR)

(21) Appl. No.: 14/338,855

(22) Filed: Jul. 23, 2014

(30) Foreign Application Priority Data
Jul. 23, 2013 (KR) 10-2013-0086966

(51) Int. Cl. H04N 21/4722; H04N 21/482; H04N 21/45; H04N 21/4788

(52) U.S. Cl. CPC H04N 21/4722; H04N 21/4788; H04N 21/4826; H04N 21/4532
USPC 725/40

(57) ABSTRACT

A method of providing information about a broadcasting program includes collecting data about at least one broadcasting program from social media, obtaining viewer response information about the at least one broadcasting program from the collected data, and displaying the obtained viewer response information as additional information about the at least one broadcasting program.

### CROSS-REFERENCE TO RELATED APPLICATIONS

This application claims the benefit of Korean Patent Application No. 10-2013-0086966, filed on Jul. 23, 2013, in the Korean Intellectual Property Office, the disclosure of which is incorporated herein in its entirety by reference.

### BACKGROUND

1. Field

One or more embodiments disclosed herein relate to a method and apparatus for providing information about a broadcasting program, and more particularly, to a technology for collecting information about a broadcasting program by using a social networking service (SNS), and for analyzing and providing the collected information for users.

2. Description of the Related Art

Recently, internet protocol TV (IPTV) broadcasting services have been launched. IPTV broadcasting, being called “internet multimedia broadcasting,” is a general name for all kinds of broadcasting services that are provided via an internet protocol network, regardless of their specific names. Since IPTV broadcasting services are conducted by an internet network, they may be combined with a variety of services provided via the internet network, including internet searching, watching movies, home shopping, home banking, and online games. Also, a duplex service may be provided between users and each of the IPTV broadcasting services and the variety of services provided via the internet network.

Meanwhile, IPTV broadcasting services may not provide broadcasting program information suitable for users, since only basic data, such as a guide of a current broadcasting program or channel and general information could be accessed through an Electronic Program Guide (EPG).

### SUMMARY

One or more embodiments of the disclosure include a method and apparatus for providing information about a broadcasting program.

One or more embodiments of the disclosure include a computer readable medium, for example, a non-transitory computer readable medium having embodied thereon one or more computer programs for executing any of the methods disclosed herein.

Additional aspects will be set forth in part in the description which follows and, in part, will be apparent from the description, or may be learned by practice of the presented embodiments.

According to one or more embodiments of the disclosure, a method of providing information about a broadcasting program may include collecting data about at least one broadcasting program from social media, obtaining viewer response information about the at least one broadcasting program from the collected data, and, based on the obtained viewer response information, displaying information about the at least one broadcasting program.

The obtaining of the viewer response information includes extracting information of at least one of viewer's gender, age, occupation, and emotional response, from the collected data; and, by using the extracted information, obtaining the viewer response information, wherein the viewer response information may include at least one of viewer's profile information and evaluation information about the broadcasting program.

The extracting of the information may include detecting data related to predetermined keywords according to the information of at least one of the viewer's gender, age, occupation, and emotional response, from the collected data.

The displaying of the information may include generating a list of recommended broadcasting programs according to a category, based on the obtained viewer response information; and displaying the list of recommended broadcasting programs, wherein the category is classified according to information of at least one of a gender, age, occupation, and emotional response.

The displaying of the information may include displaying the viewer response information for the at least one broadcasting program.

The at least one broadcasting program may include an on-air broadcasting program, and, the displaying of the information may include displaying the viewer response information about the on-air broadcasting program in real time.

The displaying of the information may include classifying the viewer response information about the at least one broadcasting program, according to a broadcasting time, and displaying the classified viewer response information.

The displaying of the information may include displaying the number of pieces of the collected data about the at least one broadcasting program, according to time.

The displaying of the information may include, when the number of pieces of data about a predetermined program exceeds a predetermined critical value, extracting the information having the highest frequency among the data about the predetermined program, and displaying the extracted information.

According to one or more embodiments of the disclosure, an apparatus for providing information about a broadcasting program may include a communication unit for collecting data about at least one broadcasting program from social media, a control unit for obtaining viewer response information about the at least one broadcasting program from the collected data, and a display unit for displaying information about the at least one broadcasting program based on the obtained viewer response information.

The control unit may extract information of at least one of viewer's gender, age, occupation, and emotional response, from the collected data, and may obtain the viewer response information by using the extracted information, wherein the viewer response information includes at least one of viewer's profile information and evaluation information about the broadcasting program.

The control unit may detect data related to predetermined keywords according to the information of at least one of the viewer's gender, age, occupation, and emotional response, from the collected data.

The display unit may generate a list of recommended broadcasting programs according to a category, based on the viewer response information, and may display the list of recommended broadcasting programs, wherein the category is classified according to information of at least one of a gender, age, occupation, and emotional response.

The display unit may display the viewer response information for the at least one broadcasting program.

The at least one broadcasting program may include an on-air broadcasting program, and, the display unit may display the viewer response information about the on-air broadcasting program in real time.

The display unit may classify the viewer response information about the at least one broadcasting program, according to a broadcasting time, and may display the classified viewer response information.

The display unit may display the number of pieces of the data about the at least one broadcasting program, according to time.

The display unit, when the number of pieces of data about a predetermined program exceeds a predetermined critical value, may extract the information having the highest frequency among the data about the predetermined program, and may display the extracted information.

According to one or more embodiments of the disclosure, a method of providing information about a broadcasting program may include collecting, by an electronic device connected to a server over a network, data about a broadcasting program from the server, obtaining viewer response information about the broadcasting program from the collected data, and displaying information about the broadcasting program, based on the obtained viewer response information.

The displaying information about the broadcasting program may include generating a plurality of lists of recommended broadcasting programs, each list corresponding to a different category obtained from the obtained viewer response information, and displaying the plurality of lists of recommended broadcasting programs together with an on-air broadcasting program. Each category may be classified according to information of at least one of a gender, age, occupation, and emotional response, and the displaying the plurality of lists of recommended broadcasting programs may include displaying at least one thumbnail image corresponding to one of the recommended broadcasting programs.

The obtaining viewer response information about the broadcasting program may include collecting data about the broadcasting program from the server by extracting data which correspond to keywords in a user profile stored on the electronic device. The extracting data may include analyzing keywords from data related to the broadcasting program, predicting at least one subject factor, and determining whether the predicted at least one subject factor corresponds to subject factor information included in the user profile.

The displaying information about the broadcasting program may include selectively displaying, according to a user selection, viewer response information corresponding to broadcasting programs broadcast before an on-air broadcasting program, broadcasting programs broadcast during an on-air broadcasting program, and broadcasting programs broadcast after an on-air broadcasting program.

A non-transitory computer readable recording medium may have embodied thereon one or more computer programs, that when executed, implements any of the methods disclosed herein.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view illustrating a system for providing information about a broadcasting program, according to an embodiment of the disclosure;

FIG. 2 is a flowchart illustrating a method of providing information about a broadcasting program, according to an embodiment of the disclosure;

FIG. 3 is a detailed flowchart illustrating a method of obtaining viewer response information, according to an embodiment of the disclosure;

FIG. 4 is a detailed flowchart illustrating a method of displaying viewer response information, according to an embodiment of the disclosure;

FIG. 5 is a detailed flowchart illustrating a method of displaying viewer response information, according to an embodiment of the disclosure;

FIG. 6 is a view illustrating a screen on which information about recommended broadcasting programs is displayed, according to an embodiment of the disclosure;

FIG. 7 is a view illustrating a screen on which at least one broadcasting program is classified according to viewer's emotional response, according to an embodiment of the disclosure;

FIG. 8 is a view illustrating a screen displaying viewer response information for at least one recommended broadcasting program, according to an embodiment of the disclosure;

FIG. 9 is a view illustrating a screen displaying viewer response information, according to an embodiment of the disclosure;

FIG. 10 is a view illustrating a screen displaying viewer response information, according to an embodiment of the disclosure; and

FIG. 11 is a block diagram of an apparatus for providing information about a broadcasting program according to an embodiment of the disclosure.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, the embodiments are merely described below, by referring to the figures, to explain aspects of the description. Expressions such as “at least one of,” when preceding a list of elements, modify the entire list of elements and do not modify the individual elements of the list.

Throughout the specification, it will be understood that when an element is referred to as being “connected” to another element, it may be “directly connected” to the other element or “electrically connected” to the other element with intervening elements therebetween. It will be further understood that when a part “includes” or “comprises” an element, unless otherwise defined, the part may further include other elements, not excluding the other elements.

Hereinafter, the disclosure will be described in detail by explaining exemplary embodiments of the disclosure with reference to the attached drawings.

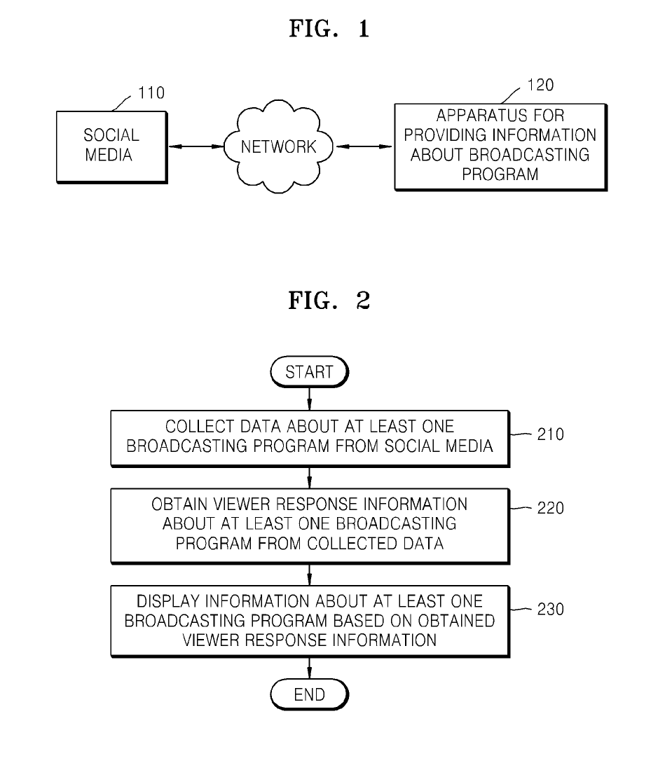

FIG. 1 is a view illustrating a system 100 for providing information about a broadcasting program, according to an embodiment of the disclosure.

Referring to FIG. 1, the system 100 for providing information about a broadcasting program may include a social networking service (SNS) server 110 such as social media and an apparatus 120 for providing information about a broadcasting program. The system 100 for providing information about a broadcasting program, illustrated in FIG. 1, shows only the components according to the example embodiment. Thus, it may be easily understood for one of ordinary skill in the art that other general-purpose components in addition to the components illustrated in FIG. 1 may also be included.

The apparatus 120 for providing information about a broadcasting program may include all apparatuses for displaying a broadcasting program. For example, the apparatus 120 may include televisions, personal computers (PCs), laptops, smart phones, and tablet PCs, but it is not limited thereto. The apparatus 120 for providing information about a broadcasting program may also include, for example, a set-top box which is connected to a display that displays the broadcasting program according to a signal provided by the set-top box.

The apparatus 120 for providing information about a broadcasting program may collect data about at least one broadcasting program from the SNS server 110. Here, the data may include bulletin board messages and exchange messages, which are written by viewers about the broadcasting program on the SNS server 110. For example, when a viewer writes an opinion after watching broadcasting program A, the written opinion may be included in the data about the broadcasting program A. Meanwhile, bulletins that are written by viewers may include not only texts but also various kinds of data including videos and images. The SNS server 110 may include, for example, any server which stores or obtains data about a broadcasting program. The data stored on or obtained by the server may include data from social media websites (e.g., TWITTER, FACEBOOK, INSTAGRAM, PINTEREST, etc.) and/or may include data stored on or obtained by the server from blogs or comments by users on websites that are related to broadcasting programs (e.g., HULU, NETFLIX, network television websites, etc.).

Meanwhile, the apparatus 120 for providing information about a broadcasting program may obtain viewer response information from the collected data. Here, the viewer response information may include at least one of viewer's profile information and evaluation information about the broadcasting program. In detail, the apparatus 120 for providing information about a broadcasting program may obtain the viewer response information about the at least one broadcasting program. For example, the apparatus 120 may obtain the viewer response information about the at least one broadcasting program by using information of at least one of (and combinations thereof) a viewer's gender, age, occupation, income information, education information, marital status, family information, and emotional response, etc., which may be extracted from the collected data. For example, the apparatus 120 for providing information about a broadcasting program may find out ages of viewers who are in favor of the program A, by extracting evaluation information about the program A and the viewer's age information, from the bulletins written by the viewers after watching the program A. A detailed method of generating the viewer response information from the data will be described later on in detail, in reference to FIG. 2.

The apparatus 120 for providing information about a broadcasting program may display information about at least one recommended broadcasting program, based on the obtained viewer response information. The information about the recommended broadcasting program may be displayed in various ways. According to an aspect of the example embodiment, the apparatus 120 for providing information about a broadcasting program may display a list of recommended broadcasting programs that is generated according to a category, based on the viewer response information. Here, the category may be classified according to information of at least one of (and combinations thereof) a gender, age, occupation, income information, education information, marital status, family information, and emotional response, etc. For example, a category may correspond to one or more broadcasting programs recommended by a married female, who is 30 to 35 years old.

Meanwhile, according to an embodiment of the disclosure, the viewer response information for at least one of the recommended broadcasting programs may be displayed. For example, a list of on-air broadcasting programs may be generated, and, for each of the on-air broadcasting programs, the viewer response information about the age, gender, occupation, income information, education information, marital status, family information, and emotional response, etc. (and combinations thereof), of the viewer of each of the on-air broadcasting programs, may also be displayed.

According to an embodiment of the disclosure, by obtaining the viewer response information by using the data collected from the SNS server 110, users may be provided with information about a broadcasting program, which is in consideration of the viewer response information.

FIG. 2 is a flowchart illustrating a method of providing information about a broadcasting program, according to an embodiment of the disclosure.

In operation 210, the apparatus 120 for providing information about a broadcasting program may collect data about at least one broadcasting program from the SNS server 110. The data may include bulletin boards messages and exchange messages, which may be written by users (e.g., viewers) about the broadcasting program on the SNS server 110.

According to an embodiment of the disclosure, as a method of collecting data, a title of the broadcasting program may be used. For example, among bulletins written by viewers on the SNS, the bulletin including or referring to the title of broadcasting program A may be collected.

Meanwhile, the method of collecting data about the broadcasting program is not limited to using the title of the broadcasting program. For example, information that may identify the broadcasting program other than the title of the broadcasting program may be used. The information that may identify the broadcasting program may include names of actors and actresses starring in the broadcasting program. For example, if the title of the broadcasting program is composed of general-purpose words, as in the movie “the way home,” as the method of collecting data, the names of the starring actors and actresses as well as the title may be used. Also, the names of the starring actors and actresses may be solely used. Additional information may be used to identify the broadcasting program, such as a name of the director, date and/or time information of the broadcasting program, genre information, season information of a program and/or episode information (e.g., season 2, episode 4 of program A).

In addition, a list of broadcasting programs may be updated in a predetermined time period. For example, if the time period is for every two months, titles of the broadcasting programs may be updated every two months. The update time may be predetermined according to a manufacturer setting, or according to a user (e.g., viewer) input, for example.

In operation 220, the apparatus 120 for providing information about a broadcasting program may obtain viewer response information about the at least one broadcasting program from the data collected in operation 210. Here, the viewer response information may be obtained, by using information of at least one of (and combinations thereof) a viewer's gender, age, occupation, income information, education information, marital status, family information, and emotional response, etc., which may be extracted from the collected data.

For extracting the information of at least one of (and combinations thereof) the viewer's gender, age, occupation, income information, education information, marital status, family information, and emotional response, etc., from the collected data, a machine learning method may be used. For example, the apparatus 120 for providing information about a broadcasting program may extract information by using keywords predetermined according to each subject factor including a gender, age, occupation, income information, education information, marital status, family information, and emotional response, etc. (and combinations thereof).

Meanwhile, the viewer response information may also include the number of the collected data about each broadcasting program. By using the number of the collected data, the apparatus 120 for providing information about a broadcasting program may determine the popularity of the broadcasting program.

In operation 230, the apparatus 120 for providing information about a broadcasting program may display information about at least one recommended broadcasting program based on the viewer response information obtained in operation 220.

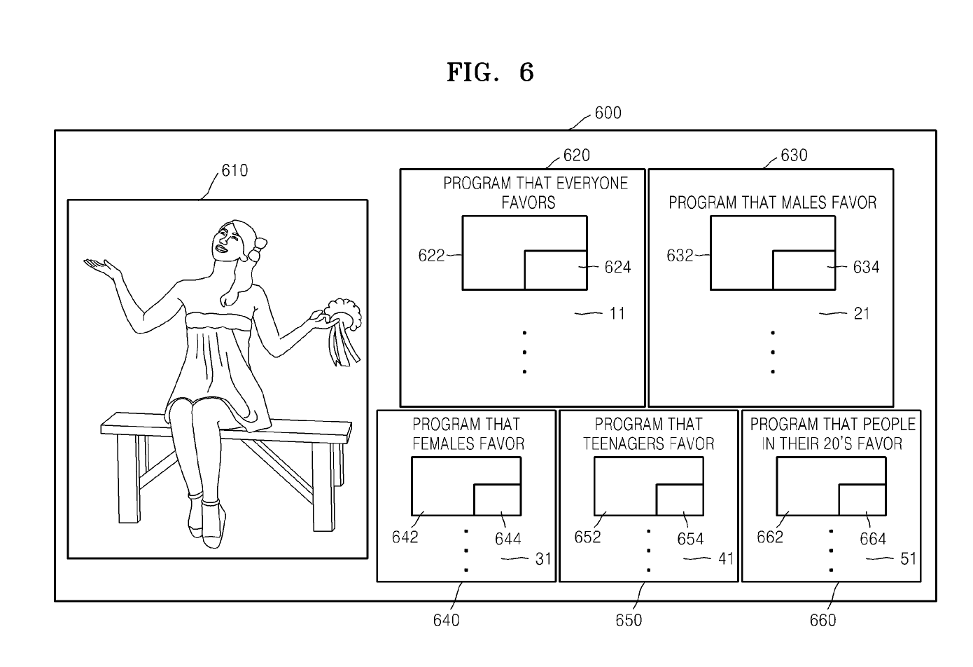

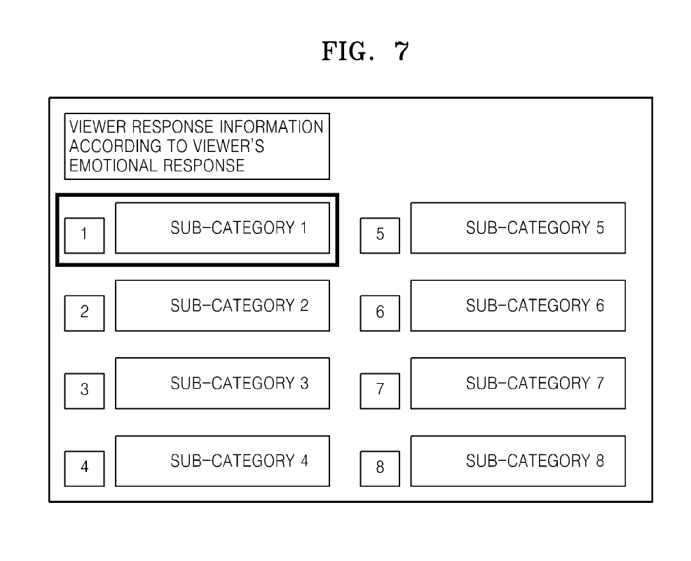

According to an embodiment of the disclosure, the apparatus 120 for providing information about a broadcasting program may display a list of recommended broadcasting programs that is generated according to a category, based on the viewer response information. For example, if the category is classified according to the age information, lists of recommended broadcasting programs that are generated according to the age category, for example, a list of broadcasting programs that teenagers favor, and a list of broadcasting programs that people in their 20's favor, may be generated and displayed. Further, if the category is classified according to a combination of viewer response information, lists of recommended broadcasting programs that are generated according to the category classification may be generated. For example, if a category is based on age information and gender information, a list of broadcasting programs that male teenagers favor, and a list of broadcasting programs that females in their 20's favor, may be generated and displayed. A method of displaying the list of recommended broadcasting programs that is generated according to the category will be described later on in detail, in reference to FIGS. 6 and 7.

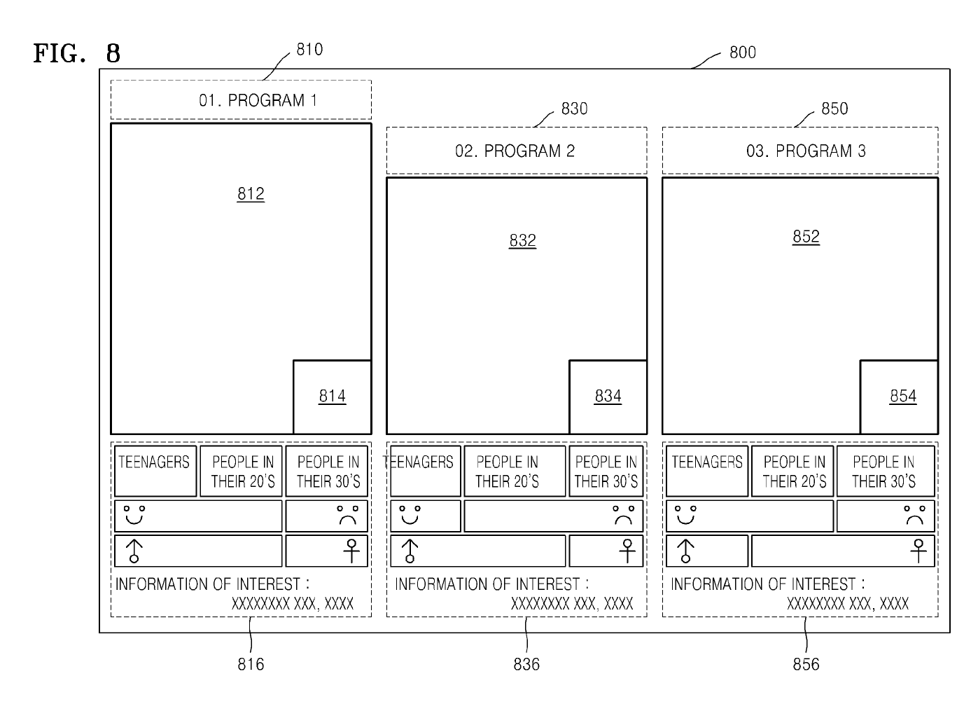

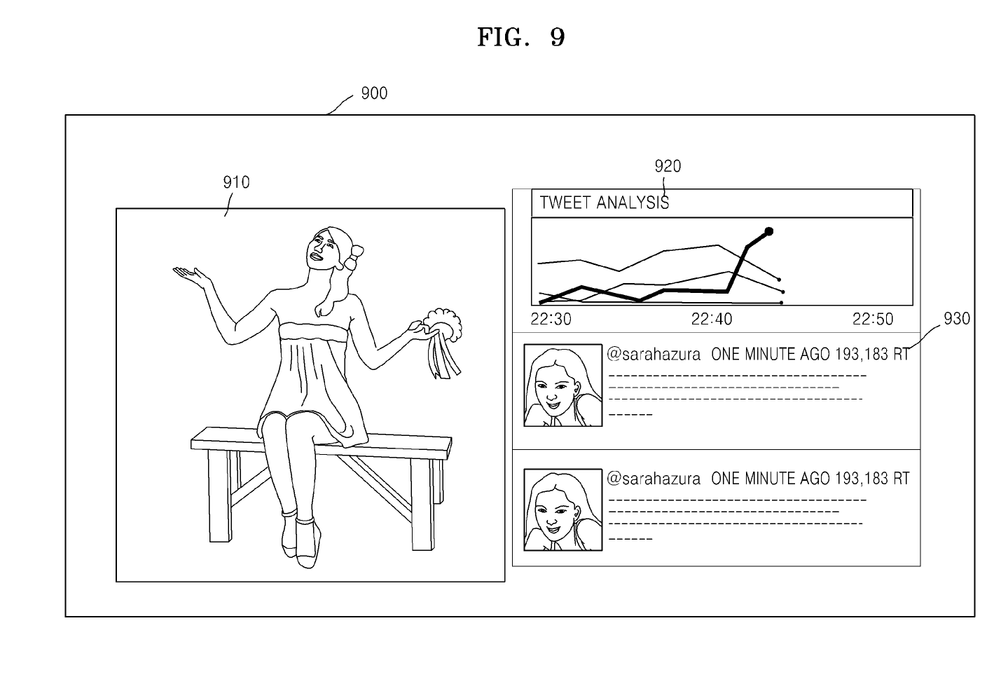

Meanwhile, according to an embodiment of the disclosure, the viewer response information may be displayed for at least one broadcasting program. For example, a list of on-air broadcasting programs may be generated, and, for each of the on-air broadcasting programs, the viewer response information (e.g., about the age, gender, occupation, income information, education information, marital status, family information, and emotional response, and combinations thereof) of the viewer of the each of the on-air broadcasting programs, may be displayed. A method of displaying the viewer response information for the at least one broadcasting program will be described later on in detail, in reference to FIG. 8.

According to an embodiment of the disclosure, data containing data related to keywords predetermined according to data collected about a certain program, may be displayed as the viewer response information. Here, the predetermined keywords may include information about the age, gender, income information, education information, marital status, family information, occupation, and the like, which may be included in a user's profile information.

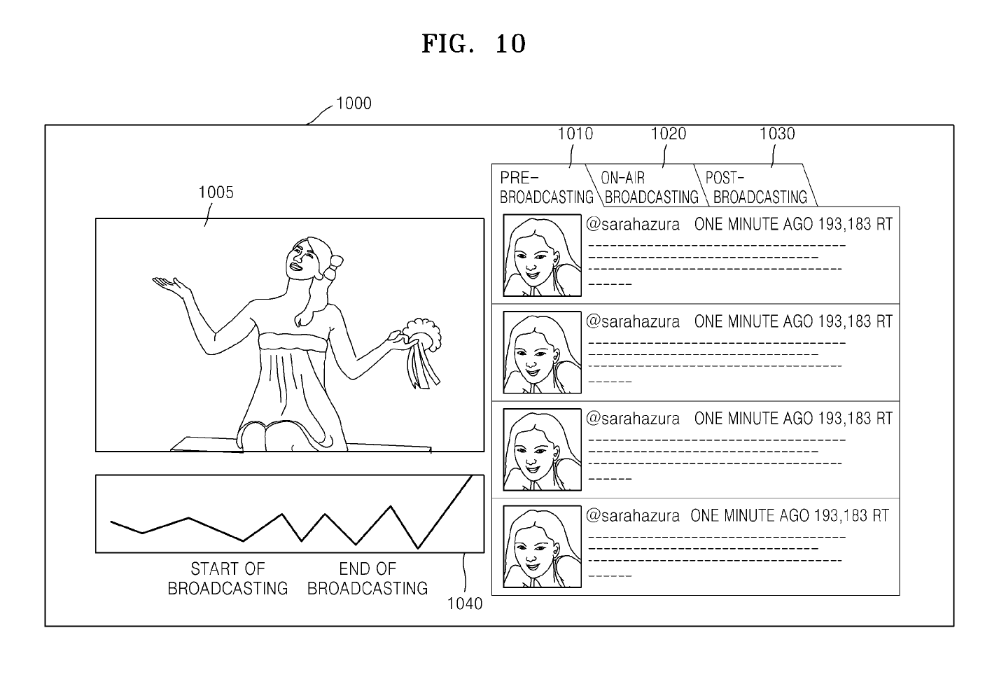

For example, the apparatus 120 for providing information about a broadcasting program may consider the user's age, gender, and occupation, extract bulletins written by viewers of similar profiles, from the collected data, and display the bulletins on a screen, as the viewer response information. Meanwhile, the predetermined keywords are not limited to the user's profile information. Depending on configurations by users, various kinds of information may be predetermined as the keywords. This aspect will be described later on in detail, in reference to FIGS. 9 and 10.

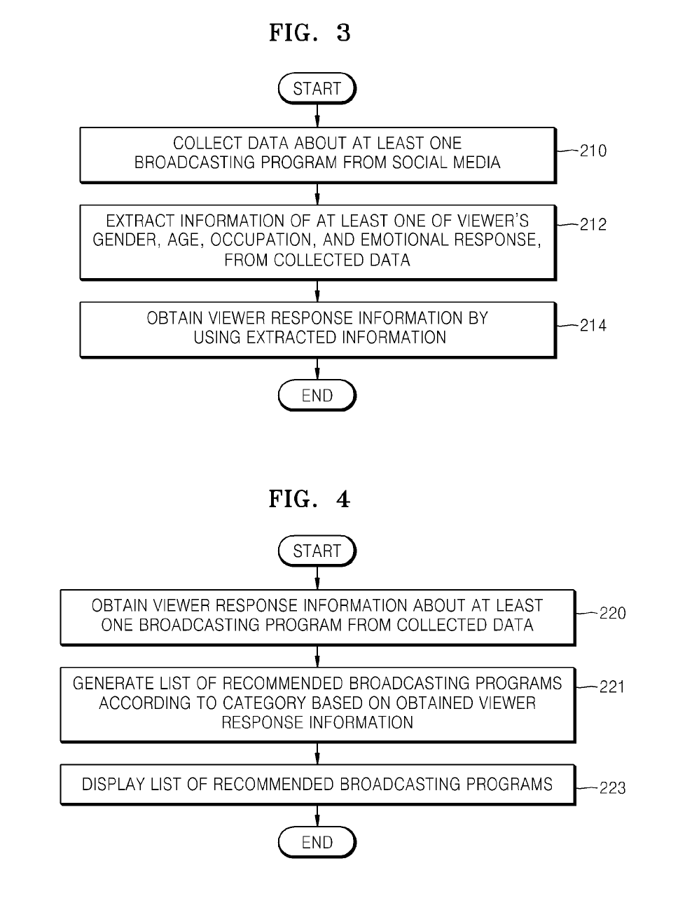

FIG. 3 is a detailed flowchart illustrating a method of obtaining viewer response information, according to an embodiment of the disclosure.

In operation 210, the apparatus 120 for providing information about a broadcasting program may collect data about at least one broadcasting program from the SNS server 110. For example, the data may include content obtained from bulletin boards messages and exchange messages, which may be written by a user (e.g. a viewer) about the broadcasting program and may be stored on the SNS server 110.

In operation 212, the apparatus 120 for providing information about a broadcasting program may extract information from the data collected in operation 210. For example, the extracted information from the data collected in operation 210 may include at least one of viewer's gender, age, occupation, and emotional response, from the data collected in operation 210. For extracting the information of at least one of the viewer's gender, age, occupation, income information, education information, marital status, family information, and emotional response, etc. (and combinations thereof) from the collected data, a machine learning method may be used. In detail, the apparatus 120 for providing information about a broadcasting program may extract information by using keywords predetermined according to each subject factor including a gender, age, occupation, income information, education information, marital status, family information, and emotional response, etc. (and combinations thereof).

For example, age information may be predicted by keywords predetermined according to one's way of speaking, a fashionable word, and a matter of concerns, according to an age group. For example, in the case of teenagers, since they often use abbreviated forms of words, the abbreviated forms of words that are often used by the teenagers may be predetermined as the keywords. If the predetermined abbreviated forms of words occur more than a predetermined number of times, (e.g., in the bulletin written by a viewer), the viewer may be estimated as a teenager.

In operation 214, the apparatus 120 for providing information about a broadcasting program may generate the viewer response information by using the information extracted in operation 212. Here, the viewer response information may be obtained by using the information of at least one of the viewer's gender, age, occupation, income information, education information, marital status, family information, and emotional response, etc. (and combinations thereof), which may be extracted from the collected data.

When the emotional response is a subject factor, the category of emotional response may include one or more sub-categories. For example, a sub-category may correspond to “touching content.” The predetermined keywords for the sub-category “touching content” may include words, such as “tears,” “touched,” and “warm.” The apparatus 120 for providing information about a broadcasting program may classify a broadcasting program into a sub-category of the emotional response category. For example, the apparatus 120 for providing information about a broadcasting program may classify broadcasting program A into the sub-category “touching content,” when the bulletin written by the viewer about the broadcasting program A includes one or more of the words, such as “tears,” “touched,” and “warm.”

Meanwhile, the viewer response information according to an embodiment of the disclosure may also include the number of the collected data about each broadcasting program. The apparatus 120 for providing information about a broadcasting program may determine the popularity of the broadcasting program by using the number of the collected data. For example, when the number of the collected data about a certain broadcasting program does not exceed a predetermined critical value, the broadcasting program may be classified as an unpopular program. Depending on configurations, the apparatus 120 for providing information about a broadcasting program may not obtain the viewer response information about the unpopular program. Alternatively, the apparatus 120 for providing information about a broadcasting program may obtain the viewer response information even if the broadcasting program is classified as unpopular.

Also, if the number of the collected data about a certain broadcasting program exceeds the predetermined critical value, the broadcasting program may be classified as a popular program. For example, for a popular program, the apparatus 120 for providing information about a broadcasting program may extract the information having the highest frequency among the data, and provide the information to the user. However, information having the highest frequency among the data for an unpopular broadcasting program may also be extracted in an alternative embodiment. Further, the disclosure is not limited to classifying a broadcasting program as popular or unpopular. For example, the broadcasting program may be rated in various manners (e.g., very unpopular, unpopular, neutral, popular, very popular, on a scale from zero to ten, etc.).

FIG. 4 is a detailed flowchart illustrating a method of displaying viewer response information, according to an embodiment of the disclosure.

In operation 220, the apparatus 120 for providing information about a broadcasting program may obtain the viewer response information about the at least one broadcasting program, from the collected data. Here, the viewer response information may be obtained by using the information of at least one of the viewer's gender, age, occupation, income information, education information, marital status, family information, and emotional response, etc. (and combinations thereof) extracted from the collected data.

In operation 221, the apparatus 120 for providing information about a broadcasting program may generate a list of recommended broadcasting programs that is generated according to a category, based on the viewer response information. For example, by using the age information of viewers of a certain program, which is extracted from the collected data, viewers' age distribution chart may be generated. Also, by using the gender information, viewers' gender distribution chart may be generated, and by using the occupation information, viewers' occupation distribution chart may be generated. Distribution charts which combine category information may also be generated (e.g., viewers' gender-age distribution chart).

Meanwhile, the viewer response information according to an embodiment of the disclosure is not limited thereto. For example, based on the emotional response information of the viewers about the at least one broadcasting program, a list of broadcasting programs categorized according to the emotional response may be generated. The list of broadcasting programs according to the emotional response may include sub-categories of touching content, comic content, and boring content, etc.

In operation 223, the apparatus 120 for providing information about a broadcasting program may display the list of recommended broadcasting programs that is generated in operation 221. According to an embodiment of the disclosure, the apparatus 120 for providing information about a broadcasting program may display a list of recommended broadcasting programs that a user selects. Also, the apparatus 120 for providing information about a broadcasting program may determine the list of recommended broadcasting programs to display, based on a user's profile. Here, the user's profile may be predetermined, for example, by a user's direct input, or based on user information recognized by a camera integrated to the apparatus 120 for providing information about a broadcasting program. For example, the apparatus 120 may store one or more programs to perform facial recognition on an image captured by a camera included in the apparatus 120. The facial recognition may be used to identify, predict, estimate, etc. certain characteristics of a viewer (e.g., age, gender, marital status, emotional response, etc.). For example, the apparatus 120 may include a microphone and store one or more programs to perform voice recognition/analysis on a voice captured by the microphone included in the apparatus 120. The voice recognition/analysis may be used to identify, predict, estimate, etc. certain characteristics of a viewer based on the content of the language (vocabulary, manner of speaking, frequency characteristics of the voice, etc.) used by the viewer (e.g., age, gender, emotional response, etc.).

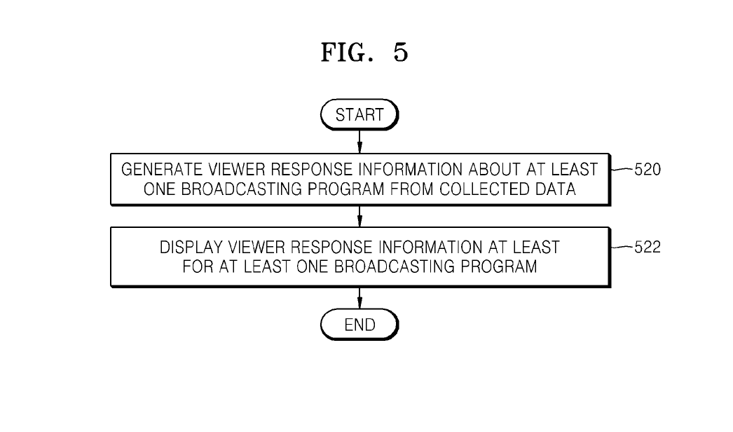

FIG. 5 is a detailed flowchart illustrating a method of displaying viewer response information, according to another embodiment of the disclosure.

In operation 520, the apparatus 120 for providing information about a broadcasting program may obtain the viewer response information about the at least one broadcasting program from the collected data. Here, the viewer response information may be obtained by using the information of at least one of the user's gender, age, occupation, income information, education information, marital status, family information, and emotional response, etc. (and combinations thereof) extracted from the collected data.

In operation 522, the apparatus 120 for providing information about a broadcasting program may display the viewer response information obtained in operation 520, for at least one recommended broadcasting program. For example, a list of on-air broadcasting programs may be generated, and, for each of the on-air broadcasting programs, the viewer response information about the age, gender, occupation, and emotional response of the viewer of the each of the on-air broadcasting programs, may be displayed. If there are an on-air broadcasting program A, an on-air broadcasting program B, and an on-air broadcasting program C, for each of the broadcasting programs A, B, and C, the viewer response information about viewers' age distribution chart, gender distribution chart, income information distribution chart, education information distribution chart, marital status distribution chart, family information distribution chart, and emotional response distribution chart, etc. (and distribution charts based on combinations thereof) may be displayed.

FIG. 6 is a view illustrating a screen 600 on which information about recommended broadcasting programs is displayed, according to an embodiment of the disclosure.

On the screen 600, the on-air broadcasting program 610 and information about at least one recommended broadcasting program based on the viewer response information, may be displayed together. Referring to FIG. 6, the information about the recommended broadcasting programs may include a list 620 of broadcasting programs that everyone favors, a list 630 of broadcasting programs that males favor, a list 640 of broadcasting programs that females favor, a list 650 of broadcasting programs that teenagers favor, and a list 660 of broadcasting programs that people in their 20's favor.

The information about the recommended broadcasting programs to be displayed may be selected by a user, or may be randomly selected by the apparatus 120 for providing Information about a broadcasting program. Also, the viewer response information suitable for (i.e., corresponding to) the user's profile may be displayed based on the user's profile information. In an alternative embodiment, the viewer response information suitable for (i.e., corresponding to) a plurality of user profiles may be displayed based on information in the plurality of user profiles. Such an alternative embodiment may be useful, for example, where there are multiple viewers who may have different attributes and/or tastes, preferences, etc. Meanwhile, information about the recommended broadcasting programs according to various categories may be displayed altogether. For example, referring to FIG. 6, information 650 and 660 about the recommended broadcasting programs according to the age, and information 630 and 640 about the recommended broadcasting programs according to the gender may be displayed together on the screen 600.

According to an embodiment of the disclosure, the information about the recommended broadcasting programs may include, for example, one or more thumbnail images about the recommended broadcasting programs, the number of the collected data, and information of interest extracted from the collected data. For example, the thumbnail image may include one or more of an image from the content of the respective broadcasting program, an image of an important or popular actor or actress from the broadcasting program, etc.

The list 620 of broadcasting programs that everyone favors may indicate (display) the one or more thumbnail images 622 about the broadcasting program in question (hereinafter, the broadcasting program 11) and additional information 624 about the broadcasting program 11. Here, for the additional information 624, the number of the data collected from the SNS server 110 regarding the broadcasting program 11, and the information of interest extracted from the collected data, may be indicated (displayed). For example, when among the data collected about the broadcasting program 11 622, the word having the highest frequency is “entertainment awards,” “entertainment awards” may be indicated or displayed as the additional information 624 of the broadcasting program 11.

Meanwhile, the list 630 of broadcasting programs that males favor, the list 640 of broadcasting programs that females favor, the list 650 of broadcasting programs that teenagers favor, and the list 660 of broadcasting programs that people in their 20's favor, may be provided, according to the categories.

The list 630 of broadcasting programs that males favor may indicate (display) the one or more thumbnail images 632 about the broadcasting program in question (hereinafter, the broadcasting program 21), and the additional information 634 about the broadcasting program 21. Here, for the additional information 634, the number of the data collected from the SNS server 110 regarding the broadcasting program 21, and the information of interest extracted from the collected data, may be indicated (displayed).

The list 640 of broadcasting programs that females favor may indicate (display) the one or more thumbnail images 642 about the broadcasting program in question (hereinafter, the broadcasting program 31), and the additional information 644 about the broadcasting program 31. Here, for the additional information 644, the number of the data collected from the SNS server 110 regarding the broadcasting program 31, and the information of interest extracted from the collected data, may be indicated (displayed).

The list 650 of broadcasting programs that teenagers favor may indicate (display) the one or more thumbnail images 652 about the broadcasting program in question (hereinafter, the broadcasting program 41), and the additional information 654 about the broadcasting program 41. Here, for the additional information 654, the number of the data collected from the SNS server 110 regarding the broadcasting program 41, and the information of interest extracted from the collected data, may be indicated (displayed).

The list 660 of broadcasting programs that people in their 20's favor may indicate (display) the one or more thumbnail images 662 about the broadcasting program in question (hereinafter, the broadcasting program 51), and the additional information 664 about the broadcasting program 51. Here, for the additional information 664, the number of the data collected from the SNS server 110 regarding the broadcasting program 51, and the information of interest extracted from the collected data, may be indicated (displayed).

As shown in FIG. 6, for each of the lists 620, 630,640, 650, 660 of broadcasting programs, one or more broadcasting programs may be displayed. For example, list 630 may show one or a plurality of programs that males favor. The lists may be displayed in a predetermined order (e.g., in order of popularity, by name, etc.). The number of programs displayed may be limited to a predetermined number (e.g., top five, top ten, etc.). The arrangement of the broadcasting programs in each list and/or number of broadcasting programs shown in each list may be set by a user, or may be a default value (e.g., according to a manufacturer setting), for example.

FIG. 7 is a view illustrating a screen on which at least one broadcasting program is classified according to a viewer's emotional response, according to an embodiment of the disclosure.

According to an embodiment of the disclosure, a list of broadcasting programs according to the viewer's emotional response may be generated, based on the viewer's emotional response information about the at least one broadcasting program. The list of broadcasting programs according to the viewer's emotional response may include sub-categories, for example, of touching content, comic content, boring content, and sad content.

For example, when the words, such as “tears,” “touched,” and “warm” occur in the bulletin written by a viewer about a broadcasting program more than a predetermined value, the broadcasting program in question may be predicted as a broadcasting program containing touching content.

FIG. 8 is a view illustrating a screen 800 displaying viewer response information for at least one recommended broadcasting program, according to an embodiment of the disclosure.

Referring to FIG. 8, the screen 800 may indicate or display titles 810, 830, and 850 of a recommend broadcasting program 1, a recommend broadcasting program 2, and a recommended broadcasting program 3, respectively. The thumbnail images 812, 832, and 852 of the recommended broadcasting programs 1, 2, and 3, respectively, may also be displayed on the screen 800. The viewer response information 816, 836, and 856 of the recommended broadcasting programs 1, 2, and 3, respectively, may also be displayed on the screen 800. Also, the thumbnail images 812, 832, and 852 of each of the recommended broadcasting programs 1, 2, and 3, may indicate or display additional information 814, 834, 854 which may correspond to the number of the data collected from the SNS server 110 regarding each of the recommended broadcasting programs 1, 2, and 3.

According to an embodiment of the disclosure, the order in which the recommended broadcasting programs 1, 2, and 3 may be displayed on the screen 800 according to a predetermined criteria. For example, the order in which the recommended broadcasting programs 1, 2, and 3 may be displayed on the screen 800 may be determined by or according to the number of the collected data. For example, the recommended broadcasting program having the highest number of the collected data may be regarded as the most popular broadcasting program and may be displayed in the first position. A broadcasting program having the second highest number of the collected data may be displayed in the second position, and so on. Meanwhile, to provide more accurate information, popular programs may be determined not merely by the number of the collected data, but alternatively or additionally by the frequency of positive words extracted within the collected data. Here, the positive words may be predetermined.

The viewer response information 816 about the recommended broadcasting program 1 may include the age information, gender information, income information, education information, marital status, family information, and emotional favorability, etc. (and combinations thereof) of the viewers of the recommended broadcasting program 1. Also, the information of interest about the recommended broadcasting program 1 may be indicated or displayed by extracting the information having the highest frequency within the collected data.

In addition, the viewer response information 836 about the recommended broadcasting program 2 may include the age information, gender information, income information, education information, marital status, family information, and emotional favorability, etc. (and combinations thereof) of the viewers of the recommended broadcasting program 2. Also, the information of interest about the recommended broadcasting program 2 may be indicated or displayed by extracting the information having the highest frequency within the collected data.

The viewer response information 856 about the recommended broadcasting program 3 may include the age information, gender information, income information, education information, marital status, family information, and emotional favorability, etc. (and combinations thereof) of the viewers of the recommended broadcasting program 3. Also, the information of interest about the recommended broadcasting program 3 may be indicated or displayed by extracting the information having the highest frequency within the collected data.

FIG. 9 is a view illustrating a screen 900 displaying viewer response information, according to an embodiment of the disclosure.

Referring to FIG. 9, on the screen 900, the on-air broadcasting program 910, the number of the data 920 collected about at least one recommended broadcasting program, and the viewer response information 930 about the on-air broadcasting program 910, may be displayed together. For example, as shown in FIG. 9, information may be shown on the screen 900 which indicates an amount of data collected as a function of time (e.g., data collected in real time while a broadcast is being shown). For example, the number of data collected 920 for an on-air program may be shown in bold, while data from other programs (which may be also be broadcasting on different channels simultaneously) may be shown without bolding.

According to an embodiment of the disclosure, the number of the data 920 collected about the at least one recommended broadcasting program may be indicated or displayed on the screen 900 according to time. The at least one recommended broadcasting program may include the on-air broadcasting program 910. The user may check the number of the data 920 collected and apprehend broadcasting programs receiving much attention from the viewers, according to a time. As shown in FIG. 9, the number of the data 920 collected may be shown graphically, for example, in the form of a line graph. However, the disclosure is not so limited, and the number of the data 920 collected may be shown in various other manners (e.g., a bar graph, a numerical display of the actual number of data collected, a pie chart, etc.).

Meanwhile, the viewer response information 930 about the on-air broadcasting program 910 may also be displayed on the screen 900. In detail, the apparatus 120 for providing information about a broadcasting program may extract data containing data related to predetermined keywords, from the data collected about the on-air broadcasting program 910.

Here, the predetermined keywords, for example, may include information from the user's profile information. The apparatus 120 for providing information about a broadcasting program may extract, for example, bulletins written by viewers of similar profiles, in consideration of the user's age, gender, occupation, income information, education information, marital status, family information, etc. (and combinations thereof) from the collected data, and may display the extracted information on the screen 900 as the viewer response information 930.

FIG. 10 is a view illustrating a screen 1000 displaying viewer response information, according to an embodiment of the disclosure.

Referring to FIG. 10, on the screen 1000, the on-air broadcasting program 1005, the viewer response information 1010, 1020, and 1030, and the number of the data 1040 collected about the broadcasting program 1005, may be indicated (displayed). As shown in FIG. 10, the number of the data 1040 collected may be shown graphically, for example, in the form of a line graph. However, the disclosure is not so limited, and the number of the data 1040 collected may be shown in various other manners (e.g., a bar graph, a numerical display of the actual number of data collected, a pie chart, etc.).

According to an embodiment of the disclosure, the apparatus 120 for providing information about a broadcasting program may extract data containing data related to predetermined keywords, from the data collected about at least one broadcasting program.

Here, the predetermined keywords, for example, may include words corresponding to the user's profile information. The apparatus 120 for providing information about a broadcasting program may extract bulletins written by viewers of similar profiles, in consideration of the user's age, gender, occupation, income information, education information, marital status, family information, etc. (and combinations thereof) which may be part of the user's profile information. The apparatus 120 for providing information about a broadcasting program may display the extracted information on the screen 1000 as the viewer response information 1010, 1020, and 1030.

According to an embodiment of the disclosure, the screen 1000 may indicate (display) the viewer response information 1010, 1020, and 1030 about at least one broadcasting program that are classified according to a broadcasting time. For example, the viewer response information 1010, 1020, and 1030 about a broadcasting program that is selected by the user may be classified into pre-broadcasting 1010, on-air broadcasting 1020, and after-broadcasting 1030. By way of example, the viewer response information may be obtained and/or displayed before a broadcasting time of the on-air (currently being shown) broadcasting program, during the broadcasting time of the on-air broadcasting program, and/or after the on-air broadcasting time of the broadcasting program. As shown in FIG. 10, the viewer response information 1010, 1020, and 1030 may be arranged using tabs such that a user is able to select any one of the tabs to selectively display one of the viewer response information 1010, 1020, and 1030. By way of example, the viewer response information may be obtained and/or displayed for broadcasting programs which have already been broadcast (before the broadcasting time of the on-air broadcasting program), for broadcasting programs which are concurrently being broadcast (during the broadcasting time of the on-air broadcasting program), and for broadcasting programs which are to be broadcast (after the broadcasting time of the on-air broadcasting program).

Meanwhile, this is merely an example embodiment of the disclosure, and, in addition to the broadcasting program that is selected by the user, the viewer response information 1010, 1020, and 1030 about on-air broadcasting programs, may be simultaneously displayed on the screen 1000.

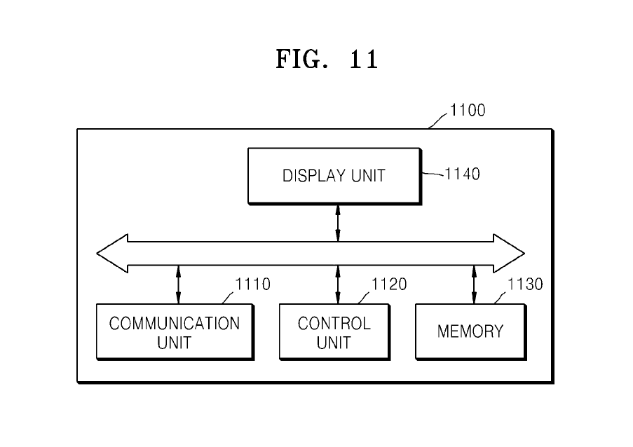

FIG. 11 is a block diagram of an apparatus for providing information about a broadcasting program according to an embodiment of the disclosure.

Referring to FIG. 11, the apparatus 1100 for providing information about a broadcasting program may include a communication unit 1110 (communicator), a control unit 1120 (controller), a memory 1130, and a display unit 1140 (display).

The apparatus 1100 for providing information about a broadcasting program illustrated in FIG. 11 shows certain components according to the disclosed embodiment for ease of explanation. Thus, it may be easily understood for one of ordinary skill in the art that other general-purpose components in addition to the components illustrated in FIG. 11 may also be included.

The communication unit 1110 may collect data about at least one broadcasting program from the SNS server 110. The data may include bulletin boards messages or exchange messages written by viewers about the broadcasting program on the SNS server 110. The communication unit 1100 may be embodied by, for example, one or more of (and combinations thereof), a transceiver, a transmitter-receiver, a communication interface, a network interface, and the like.

According to aspects of the above-described embodiments, the communication unit may perform various operations over a wired or wireless network, or a combination thereof. For example, the communication unit 1100 may collect data from the SNS server 110 over a network in a wired and/or wireless manner. The network may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, Zigbee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like.

According to an embodiment of the disclosure, as a method of collecting data, a list about the at least one broadcasting program may be used. Here, the list may include not only a title of the broadcasting program, but also other information that may identify the broadcasting program. For example, titles of broadcasting programs and names of starring actors and actresses, directors, character names, etc., may be included.

The control unit 1120 may obtain viewer response information about the at least one broadcasting program from the collected data. Here, the viewer response information may be obtained by using information of at least of one of a viewer's gender, age, occupation, income information, education information, marital status, family information, and emotional response, etc. (and combinations thereof), extracted from the collected data. The control unit 1120 may be embodied as a controller comprising at least one processor, for example.

In detail, the information of at least one of the viewer's gender, age, occupation, income information, education information, marital status, family information, and emotional response, etc. (and combinations thereof), may be extracted from the collected data. For example, the age information may be predicted by using keywords predetermined according to one's way of speaking, a fashionable word, and a matter of interests, according to an age group.

The control unit 1120 may obtain the viewer response information by using the extracted information. In detail, for the at least one broadcasting program, the extracted information may be classified according to the gender, age, occupation, income information, education information, marital status, family information, and emotional response, etc. (and combinations thereof). By obtaining the viewer response information by classifying, according to a category, the information extracted from bulletins or exchange messages written by viewers about a certain broadcasting program, information about broadcasting programs may be provided to a user more efficiently.

The memory 1130 may store the keywords that are predetermined according to a gender, age, occupation, income information, education information, marital status, family information, and emotional response, etc., in order to extract the information of at least one of the viewer's gender, age, occupation, income information, education information, marital status, family information, and emotional response, etc. (and combinations thereof) from the collected data. Also, the memory 1130 may store one or more users' profile information. For example, the memory 1130 may be embodied as a storage medium, such as a nonvolatile memory device, such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, or combinations thereof. However, examples of the memory 1130 are not limited to the above description, and the memory 1130 may be realized by other various devices and structures as would be understood by those skilled in the art.

The display unit 1140 may display additional information about at least one recommended broadcasting program, based on the obtained viewer response information. According to an embodiment of the disclosure, the apparatus 120 for providing information about a broadcasting program may display a list of recommended broadcasting programs that is generated according to a category, based on the viewer response information. For example, when the category is classified according to age information, lists of broadcasting programs recommended according to an age group, such as a list of broadcasting programs that teenagers favor and a list of broadcasting programs that people in their 20's favor may be generated and displayed to the user. For example, when the category is classified according to age and gender information, lists of broadcasting programs recommended according to an age and gender group, such as a list of broadcasting programs that male teenagers favor and a list of broadcasting programs that females in their 20's favor may be generated and displayed to the user. The display 1140 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, or combinations thereof, for example. However, the disclosure is not limited to these example displays and may include other types of displays.

According to an embodiment of the disclosure, the apparatus 120 for providing information about a broadcasting program may display a list of recommended broadcasting programs that the user selects. Meanwhile, the apparatus 120 for providing information about a broadcasting program may determine the list of recommended broadcasting programs to display, based on the user's profile. Here, the user's profile may be predetermined by a user's direct input, or based on the user information recognized by a camera integrated to the apparatus 120 for providing information about a broadcasting program.

Meanwhile, according to an embodiment of the disclosure, the viewer response information may be displayed for the at least one recommended broadcasting program. For example, a list of on-air broadcasting programs may be generated, and, the viewer response information about the age, gender, occupation, income information, education information, marital status, family information, and emotional response, etc. (and combinations thereof) of the viewers of each of the on-air broadcasting programs may be displayed.

The device described herein may comprise a processor, a memory for storing program data and executing it, a permanent storage such as a disk drive, a communication port for handling communications with external devices, and user interface devices, etc. Any processes may be implemented as software modules or algorithms, and may be stored as program instructions or computer readable codes executable by a processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner.

As stated above, the device and methods according to the above-described example embodiments may use one or more processors. For example, a processing device may be implemented using one or more general-purpose or special purpose computers, and may include, for example, one or more of a processor, a controller and an arithmetic logic unit, a central processing unit (CPU), a graphics processing unit (GPU), a digital signal processor (DSP), a microcomputer, a field programmable array, a programmable logic unit, an application-specific integrated circuit (ASIC), a microprocessor or any other device capable of responding to and executing instructions in a defined manner.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the disclosure, reference has been made to the exemplary embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art. For example, example screen shots have been provided in the figures to explain the various disclosed embodiments. However, the disclosure is not limited to these example screen shots which are provided for purposes of illustration and explanation. The contents displayed on a screen may be arranged in a different manner and are not limited to the manner in which the contents are arranged as shown in the figures.

The disclosure may be described in terms of functional block components and various processing steps. Such functional blocks may be realized by any number of hardware and/or software components configured to perform the specified functions. For example, the disclosure may employ various integrated circuit components, e.g., memory elements, processing elements, logic elements, look-up tables, and the like, which may carry out a variety of functions under the control of one or more microprocessors or other control devices. Similarly, where the elements of the disclosure are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the disclosure could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the disclosure unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of all methods described herein can be performed in any suitable order unless otherwise indicated herein or otherwise clearly contradicted by context. For example, two blocks (operations) shown in succession may in fact be executed substantially concurrently (simultaneously) or the blocks (operations) may sometimes be executed in the reverse order, depending upon the functionality involved. The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to those of ordinary skill in this art without departing from the spirit and scope of the disclosure.

It should be understood that the exemplary embodiments described therein should be considered in a descriptive sense only and not for purposes of limitation. Descriptions of features or aspects within each embodiment should typically be considered as available for other similar features or aspects in other embodiments. For example, embodiments described with respect to certain figures should not be considered as mutually exclusive with respect to embodiments described with respect to other figures. To the contrary, unless explicitly stated otherwise, example embodiments described with respect to a certain figure should be considered to be equally applicable, compatible, and/or interchangeable with embodiments described with respect to other figures.

While one or more embodiments of the disclosure have been described with reference to the figures, it will be understood by those of ordinary skill in the art that various changes in form and details may be made therein without departing from the spirit and scope of the disclosure as defined by the following claims.

What is claimed is:

1. A method of providing information about a broadcasting program, the method comprising:
collecting data about a broadcasting program from social media;
obtaining, using one or more processors, viewer response information about the broadcasting program from the collected data; and
displaying information about the broadcasting program, based on the obtained viewer response information.

2. The method of claim 1, wherein the obtaining of the viewer response information comprises:
extracting information of at least one of viewer's gender, age, occupation, and emotional response, from the collected data; and
obtaining the viewer response information by using the extracted information,
wherein the viewer response information comprises at least one of a viewer's profile information and evaluation information about the broadcasting program.

3. The method of claim 2, wherein the extracting of the information of the at least one of the viewer's gender, age, occupation, and emotional response, comprises detecting data related to predetermined keywords according to the information of the at least one of the viewer's gender, age, occupation, and emotional response, from the collected data.

4. The method of claim 1, wherein the displaying of the information comprises:
generating a list of recommended broadcasting programs according to a category, based on the obtained viewer response information; and
displaying the list of recommended broadcasting programs,
wherein the category is classified according to information of at least one of a gender, age, occupation, and emotional response.

5. The method of claim 1, wherein the displaying of the information comprises displaying the viewer response information for the broadcasting program.

6. The method of claim 1, wherein the broadcasting program comprises an on-air broadcasting program, and, the displaying of the information comprises displaying the viewer response information about the on-air broadcasting program in real time.

7. The method of claim 1, wherein the displaying of the information comprises:
classifying the viewer response information about the broadcasting program according to a broadcasting time; and
displaying the classified viewer response information.

8. The method of claim 1, wherein the displaying of the information comprises displaying the number of the collected data about the broadcasting program, according to time.

9. The method of claim 8, wherein the displaying of the information further comprises:
when the number of pieces of data about a predetermined program exceeds a predetermined critical value, extracting information having the highest frequency among the data about the predetermined program; and
displaying the extracted information.

10. An apparatus for providing information about a broadcasting program, the apparatus comprising:
a communicator to collect data about a broadcasting program from social media;
a controller to obtain viewer response information about the broadcasting program from the collected data; and
a display to display information about the broadcasting program, based on the obtained viewer response information.

11. The apparatus of claim 10, wherein the controller:
extracts information of at least one of viewer's gender, age, occupation, and emotional response, from the collected data; and
obtains the viewer response information by using the extracted information,
wherein the viewer response information comprises at least one of viewer's profile information and evaluation information about the broadcasting program.

12. The apparatus of claim 11, wherein the controller detects data related to keywords predetermined according to the information of the at least one of the viewer's gender, age, occupation, and emotional response, from the collected data.

13. The apparatus of claim 10, wherein the display:
generates a list of recommended broadcasting programs according to a category, based on the obtained viewer response information; and
displays the list of recommended broadcasting programs,
wherein the category is classified according to information of at least one of a gender, age, occupation, and emotional response.

14. The apparatus of claim 10, wherein the display displays the viewer response information for the broadcasting program.

15. The apparatus of claim 10, wherein the broadcasting program comprises an on-air broadcasting program, and, the display displays the viewer response information about the on-air broadcasting program in real time.

16. The apparatus of claim 10, wherein the display classifies the viewer response information about the broadcasting program, according to time, and displays the classified viewer response information.

17. The apparatus of claim 10, wherein the display, displays the number of the collected data about the broadcasting program, according to time.

18. The apparatus of claim 17, wherein the display, when the number of pieces of data about a predetermined program exceeds a predetermined critical value, extracts information having the highest frequency among the data about the predetermined program; and displays the extracted information.

19. A non-transitory computer readable recording medium having embodied thereon one or more computer programs, that when executed, implements the method of claim 1.
